(19) United States
(12) Patent Application Publication
(10) Pub. No.: US 2004/0188885 A1
(43) Pub. Date: Sep. 30, 2004

(54) Instrument panel assembly and method of forming same

(76) Inventors: Luis Lorenzo, Midland, MI (US); David L. Chapman, Lake Orion, MI (US)

Correspondence Address: Scott A. Chapple, Dobrusin & Thennisch PC, Suite 311, 401 South Old Woodward Avenue, Birmingham, MI, 48009, US

(21) Appl. No.: 10/403,603

(22) Filed: Mar. 31, 2003

(51) Int. Cl. B29C 43/20; B29C 45/16

(52) U.S. Cl. 264/328.1; 264/250; 264/320

(57) ABSTRACT

There is disclosed an instrument panel assembly and a method of forming the same. The instrument panel assembly preferably includes one or more frames or structures that are at least partially formed of plastic. The assembly also preferably includes a reinforcement structure for assisting the instrument panel assembly in supporting a peripheral component such as a steering wheel column.

### TECHNICAL FIELD

The present invention relates to an instrument panel assembly and a method of forming the same. More particularly, the present invention relates to an instrument panel assembly suitable for assembly to an automotive vehicle for assisting in support of a steering column.

### BACKGROUND OF INVENTION

Generally, the transportation industry has sought to form assemblies for transportation vehicles that exhibit structural integrity, relatively low weight and, preferably, a combination of both. For example, it may be desirable for an instrument panel assembly of an automotive vehicle to exhibit sufficient structural integrity for supporting one or more peripheral components such as air bag assemblies, instruments, fuse boxes, steering columns or the like. At the same time, it may be desirable for the instrument panel assembly to maintain a low weight to assist in maintaining an overall lower weight for the vehicle.

In addition to low weight and structural integrity, industry has also sought to produce assemblies that provide design flexibility for accommodating various functional systems. For example, it may be desirable for an instrument panel assembly to accommodate a heating, ventilation and air conditioning (HVAC) system or one or more other components.

Accordingly, the present invention provides an assembly, and more particularly an instrument control panel assembly that exhibits relatively low weight, high structural integrity, increased design flexibility or a combination thereof and also preferably assists in supporting one or more peripheral components such as a steering column.

### SUMMARY OF THE INVENTION

The present invention provides an instrument panel assembly having at least one frame and preferably a plurality of frames (e.g., a main frame and a secondary frame). Each of the frames is preferably formed of a plastic material. When formed of plural frames, an adhesive, a weldment, a mechanical fastener, a combination thereof or other attachment is preferably provided for attaching the frames together. The instrument panel assembly also includes a reinforcement structure for assisting in supporting a component such as a steering column or other supported component of the vehicle. One or more attachments are preferably employed for attaching the reinforcement structure to the one or more frames.

### DESCRIPTION OF THE DRAWINGS

FIG. 1 is an exploded perspective view of an exemplary instrument panel assembly according to an aspect of the present invention.

FIG. 2 is an assembled perspective view of the instrument panel assembly of FIG. 1.

FIG. 3 is an assembled cut away view of a section the instrument panel assembly of FIG. 1.

FIG. 4 is a perspective view of a portion of the instrument panel assembly of FIG. 1.

### DETAILED DESCRIPTION OF THE PREFERRED EMBODIMENT

The present invention is predicated upon the provision of an instrument panel assembly having at least one frame and optionally at least one reinforcement structure. The at least one reinforcement structure is preferably configured for assisting in supporting one or more peripheral components. For example in one preferred embodiment, a reinforcement structure bridges two or more portions of a frame, such as the region below a steering column of an automotive vehicle, for supporting a component (such as a steering column), for imparting cross-vehicle rigidity, for resisting flexure of the frame or a combination thereof.

When more than one frame is employed to form the instrument panel assembly, an adhesive may be used to adhere one frame to another, however, it is contemplated that other attachments or attachment methods may be alternatively or additionally employed, such as an adhesive, a weldment, a mechanical fastener, a combination thereof or other attachment. Preferably, the one or more frames are also configured to accommodate other vehicle system components.

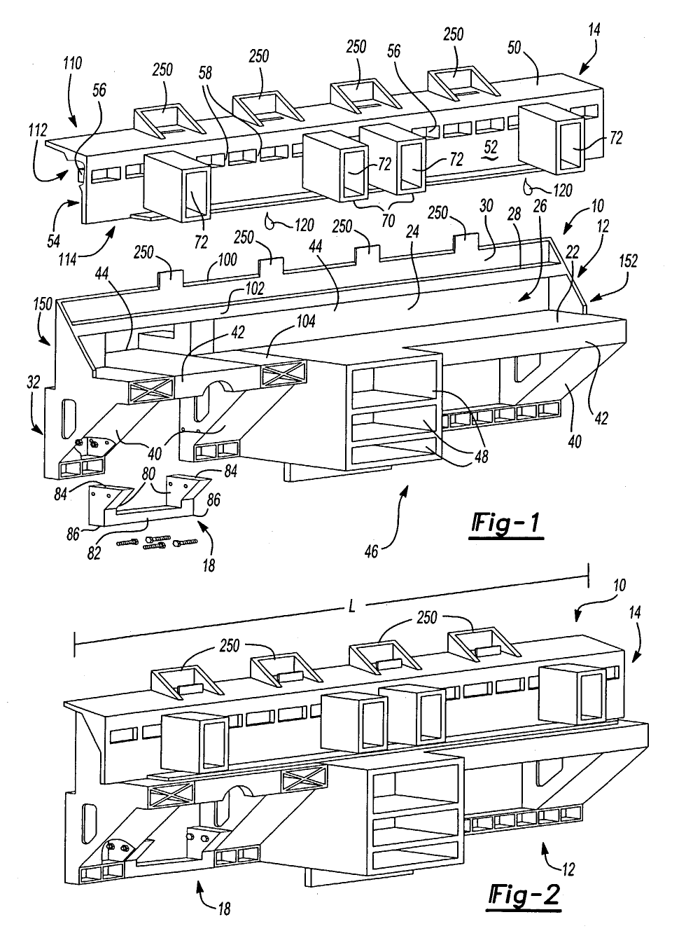

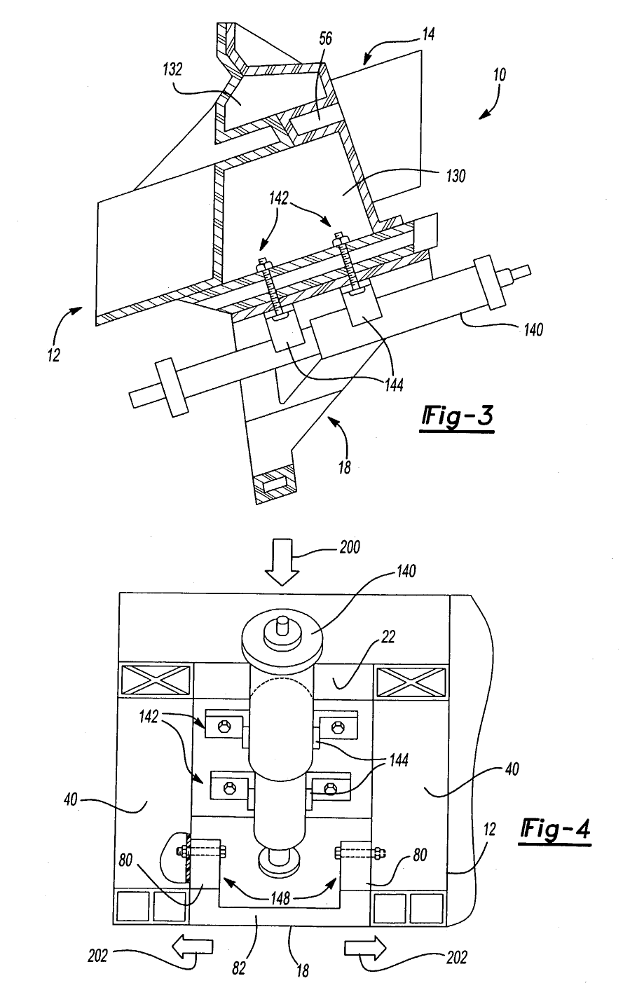

Referring to FIGS. 1-3, there is illustrated an exemplary instrument panel assembly 10 in accordance with the present invention. The assembly 10 preferably includes at least one frame and at least one reinforcement structure. The assembly 10 illustrated includes a main frame 12, a secondary frame 14 and an optional bridging member, enclosure member, reinforcement or combination thereof, as shown generally by reference numeral 18 in FIG. 1.

The main frame 12 may be configured in a variety of shapes and sizes, and may include decks, shelves, slots or other openings or support surfaces. The main frame 12 is preferably configured to extend laterally across partially or substantially an entire internal cabin area of a transportation vehicle. By way of example, in the illustrated embodiment, the main frame 12 includes at least a first portion 22 (which is illustrated as substantially planar) that extends substantially laterally and horizontally to effectively define a deck. The main frame 12 also includes a second portion 24 (also illustrated as substantially planar) that extends substantially laterally and vertically and adjoins the first portion 22. As shown, the first and second portions 22, 24 are adjoining and cooperatively form a window opening 26 (i.e., a cavity) that extends laterally with the portions 22, 24. Optionally, the first frame 12 may also include a third portion 28 that is shown as substantially parallel to the first portion 22 and which cooperatively forms another window opening 30 (i.e., another cavity) that extends laterally with the second and third portions 24, 28.

Preferably, the main frame 12 includes one or more support members for supporting the first planar portion 22. For example, as illustrated, there are four laterally spaced apart sloped bracket support members 40 that extend upwardly from a lower area 32 of the main frame 12 to an edge 42 of the first portion 22. In this manner, the sloped support members 40 and the portion 22 cooperatively form triangular configurations that assist in providing the instrument panel assembly with structural integrity. Of course, greater or fewer support members may be employed and such support members may also have alternative shapes, configurations, locations or the like. For example, they may have a curvature instead of being planar.

Optionally, the instrument panel assembly 10, and more particularly, the support members 40 may include one or more predetermined failure structures that are designed to fracture or otherwise fail upon application of a predetermined load. Such failure structures can assist in managing energy in the event of an impact. For example, in one embodiment, the support members 40 could include selective collapsible members (e.g., metallic shear plates) having collapsible structures (e.g., triangular configurations, locally thinned sections, or otherwise) that are configured to bend, fracture or otherwise fail upon placement of a predetermined load upon the members by an object. For example, it might be possible to reduce the occurrence of a leg injury by the design of a support member 40

It is also preferable for the first frame 12 to include one or more openings (e.g., cavities, through-holes or the like) for accommodating peripheral components. As shown, the main frame 12 includes an opening 44 (e.g., a through-hole) in the second portion 24 for accommodating an HVAC system. The main frame 12 also includes a central block shaped construction 46 with one or more shelves that defines a plurality of openings 48 (e.g., through-holes or cavities) suitable for accommodating audio, video or other infotainment systems, gauges, instruments, navigation systems, climate control component, power supplies, electronic hardware, sensors, storage receptacles or other peripheral components. The frame may be suitably configured to receive the components and secure them in place with a slotted joint, a snap fit, a quick connector or some other mechanical attachment with or without the use of an intermediate bracket, seal or other structure for absorbing energy.

Like the first frame 12, it is contemplated that the second frame 14 may be formed in a variety of shapes and configurations. The frame 14 is preferably configured to extend laterally across substantially an entire internal cabin area of a transportation vehicle, but may extend only partially across. In the illustrated embodiment, the second frame 14 includes a first portion 50 (shown as substantially planar) that extends substantially laterally, horizontally or both. The second frame 14 also includes a second portion 52 (also shown as substantially planar) that extends substantially laterally, vertically or both. As shown, the first and second planar portion 50, 52 are adjoining and cooperatively form a opening 54 (i.e., a cavity) that extends laterally with the portions 50, 52.

The second frame 14 optionally includes a protrusion 56 extending from the second portion 52 into the opening 54. As shown, the protrusion 56 is generally rectangular an extends laterally with the second portion 52. The protrusion 56 is also shown as substantially hollow for accommodating a plurality of reinforcing slats 58, but may be shaped in a variety of configurations.

It is also preferable for the second frame 14 to include one or more openings (e.g., cavities, through-holes or the like) for accommodating peripheral components such as as HVAC systems, stereo components, gauges, knobs etc. As shown, the second frame 14 includes a plurality (e.g., four) tubular structures 70 that define openings 72 (i.e., ducts or tunnels) extending through the tubular structures 70. As shown, the tubular structures 70 are rectangular in cross-section, but may be alternatively configured or shaped. It is also generally contemplated that various functions or portion of the second frame 14 may be changed to become attributes of the first frame 12 or vice versa. It will be appreciated that the frames and structures herein are variable depending upon the intended application. One advantage of the present invention is that, because one or more of the frames or structures can be formed of plastic, intricate shapes are possible.

The reinforcement structure 18 is illustrated as a bridge providing structural integrity to the main frame 12 for supporting a steering column, but it may be alternatively configured and it may be employed to support a variety of components of a transportation vehicle or other articles of manufacture. The reinforcement structure may be block-shaped, U-shape, arcuate, angular, continuous, discontinuous, a combination thereof or otherwise shaped and configured as desired. According to a preferred embodiment, the reinforcement structure forms, by itself or in conjunction with other structures, one or more triangular portions for imparting structural integrity, cross car continuity or a combination thereof to the reinforcement structure.

The reinforcement structure 18 is illustrated as including three members or portions, but may include greater or fewer. More specifically, the reinforcement structure is illustrated as having a pair of attachment members 80 that are attached to (e.g., bridged by and integrally formed with) a central structural member 82. Preferably, the attachment members 80 are substantially triangular and include at least one attachment portion 84 that is illustrated as planar, but which may be otherwise configured as well. In a preferred embodiment, the central member 82 bridges from a corner 86 of one attachment member 80 to a corner 86 of the other attachment member 80, but may bridge the members 80 at other locations. The corners 86 are shown in their preferred locations opposite the attachment portions 84 of the attachment members 80.

The one or more frames and the reinforcement structure of the instrument panel assembly may be formed of a variety of materials such as metals (e.g., steel, magnesium, aluminum combinations thereof or the like), polymeric materials or other materials. Moreover, each frame and/or each reinforcement structure may be formed of the same or different materials.

In one preferred embodiment, one or a combination of the frames and reinforcement structures of the present invention are made from a plastic material, and more preferably a thermoplastic material. In a particularly preferred embodiment, the frames and structures are made from a high strength thermoplastic resin selected from styrenics, polyamides, polyolefins, polycarbonates, polyesters or mixtures thereof. Still more preferably they are selected from the group consisting of acrylonitrile butadiene styrene, polycarbonate/acrylonitrile/butadiene styrene, polycarbonate, polyphenylene oxide/polystyrene, polybutylene terephthalate, polyphenylene oxide, polyphenylene ether, syndiotactic polystyrene, ethylene alpha olefin, polybutylene terephthalate/polycarbonate, polyamide (e.g., nylon), polyesters, polypropylene, polyethylene, polyethylene terephthalates, mixtures, alloys and blends thereof.

It is contemplated that the plastics materials for making the frames and structures may be provided as neat resins, blends or otherwise. Moreover, the polymeric materials may incorporate natural, mineral, fibrous or other fillers of various shapes and sizes for providing reinforcing, stiffening or other characteristics to the frames or structures.

In other preferred embodiments, the plastics material for one or more of the frames or reinforcement structure may comprise a homopolymer, for example a polyolefin, a polyamide, a polyphenylene oxide and polystyrene, or a copolymer, for example a polyalkylene terephthalate.

In other embodiments, the plastic material may be a thermosetting plastic resin. For example, a polyurethane system may be employed for forming the one or more frames, the reinforcement structure or both.

The plastics material may contain fibre, for example short glass fibre, long glass fibre, short natural fibre or long natural fibre. Other preferred plastic materials may include talc, minerals or the like. Advantageously, it has been found that relatively long glass fibers add a relatively high degree of strength. Thus, in preferred embodiments, a polymeric material such as ABS, PC\ABS, polypropylene or another suitable plastic is filled with glass fibers having an average length of approximately greater than 2 mm, more preferably greater than about 4 mm even more preferably greater than about 6 mm and most preferably between about 8 mm and 20 mm.

It is possible to form the frames, the reinforcement structure or both using art-disclosed techniques for the fabrication of the material selected. Thus, for example, the frames or reinforcement structure may be formed, molded, machined or otherwise configured to the desired shape. Metal structures may be roll formed, cast, stamped or the like.

Where the frames and reinforcement structure are plastic, it is possible to use any suitable plastic fabrication technique including, without limitation, injection molding (including but not limited to external or internal gas injection molding), blow molding, compression molding, rotational molding, thermoforming, extruding, vacuum forming, foaming-in-place, or otherwise. Accordingly, as can be appreciated, in one embodiment, hybrid instrument panel assemblies can be fabricated, thereby taking advantage of the benefits of different respective materials and different respective fabrication techniques, and also advantageously permitting for the ability to design additional features.

For thermosetting materials, any suitable forming techniques may be used. For example, reaction injection molding (RIM) techniques may be employed. Preferred RIM techniques might include structural reaction injection molding (SRIM), reinforced reaction injection molded (RRIM), low density reaction injection molded (LD-RIM) (which may be reinforced or structural) or the like. Alternative techniques such as resin transfer molding (RTM) may also be employed.

Fillers appropriate for RIM (e.g., RRIM or LD-RRIM) materials include, without limitation, mineral quasi-isotropic particles such as mica or wollastonite having various aspect ratios. Reinforcements suitable for RIM (e.g., SRIM or LD-RIM) materials include, without limitation, spray-up fiber preforms, oriented fiber preforms, random fiber preforms, or single or multiple fiber reinforcing layers preplaced in the manufacturing tools prior to injection of the resin.

For forming the instrument panel assembly 10, the one or more frames and the one or more reinforcement structures are attached together. Moreover, the one or more reinforcement structures, the one or more frames or a combination thereof are attached to one or more peripheral components and are preferably attached to the steering wheel column.

Attachment of the frames, the reinforcement structures, the peripheral components or a combination thereof together may be accomplished according to a variety of suitable techniques. For example, the structures, frames and components may be adhered to each other, integrally formed with each other, interference fit to each other, fastened to each other with fasteners or a combination thereof. Exemplary mechanical fasteners might include screws, clips, rivets, interlocking devices combinations thereof or the like. Moreover, such attachments may be integrally formed with or separate from the frames or reinforcement structures. Alternatively or additionally, the frames, the reinforcement structures and peripheral components may be integrated together by molding at least a portion of one frame or structure about another frame or structure, component or fastener according to one of the molding techniques described herein. As other alternatives or other additions, heat staking, vibrational welding, sonic welding, laser welding, hot plate welding combinations thereof or the like may be employed.

In the preferred embodiment illustrated, the first frame 12 is attached with the second frame 14. Preferably, the first frame 12 includes one or more mating or corresponding surfaces 100, 102, 104 that are configured to oppose, contact or both one or more mating or corresponding surfaces 110, 112, 114 of the second frame 14. In the preferred embodiment, the mating surfaces 100, 102, 104 of the first frame 12 are preferably attached to the mating surfaces 110, 112, 114 of the second frame 14 by locating an adhesive 120 between the surfaces. Such an adhesive may be dabbed, poured, brushed, sprayed, rolled or otherwise applied to one or more of the corresponding surfaces followed by moving the corresponding surfaces 100, 102, 104 of the first frame 12 respectively toward the corresponding surfaces 110, 112, 114 of the second frame 14. Alternatively, however, any other suitable attachment method such as vibrational welding, heat staking or otherwise may be employed to attach the corresponding surfaces together.

When used, any suitable adhesive may be employed in the present invention. Preferably, the adhesive is compatible with (i.e., capable of adhering to) the material of the surfaces of the frames, the reinforcement structure or both. If, however, the adhesive is slightly incompatible with one of these materials, it may be desirable to treat the surface[s] formed of the incompatible material. Exemplary treatments include the application of primer, exposure to plasma, combinations thereof or the like.

In one embodiment, the adhesive is a urethane based adhesive, and more preferably a urethane adhesive. Alternatively, the adhesive may include a functional component selected from acrylonitrile butadiene styrene (ABS), polycarbonate (PC), or a mixture thereof (e.g. PC-ABS). In a further alternative embodiment the adhesive is a silane adhesive, a silicone adhesive or a mixture thereof. In yet another embodiment, the adhesive is an acrylic adhesive. The adhesive may also be epoxy based. It may include polyolefinics, styrenics, acrylics or mixtures thereof. In yet another embodiment, a preferred adhesive includes alkyl borane. Examples of suitable adhesives are disclosed in commonly owned U.S. patent Ser. No. 09/466,321 (filed Dec. 17, 1999) and patent publication numbers 20020058764 and 20030001410 expressly incorporated herein by reference for all purposes. Any such adhesive may include suitable performance modifiers including art disclosed tackifiers, elastomers, impact modifiers, or the like.

In one embodiment, a two part, organoborane/amine complex adhesive or other adhesive is employed for adhesively securing combinations of the frames, the reinforcement structures or both together. Advantageously, such an adhesive can adhere to low surface energy surfaces or substrates. As such, the adhesive is preferably capable of bonding to corresponding surfaces having a surface energy of less than 45 mJ/m².

Adhesives, polymerizable compositions and method of use disclosed in International Patent Application No. PCT/US00/33806, incorporated herein by reference, are especially preferred for use in the present invention to bond the frames and structures.

Once the adhesive 120 has been applied, it will typically require some amount of time to cure (e.g., part cure, full cure, cure on demand, air cure, heat cure, moisture cure, chemical cure, radiation cure, or the like). Preferably, the adhesive cures at about room temperature (e.g., between about 20° C. to about 30° C.), but may be exposed to elevated or lowered temperatures for accelerating or slowing cure times. During cure, it may be desirable to employ a device (e.g., push-pins, clamps, clips or the like) for holding the frames and/or structures together. Such fasteners may be removable or may be intended to assist in securing the the frames and/or structures together during use of the panel assembly 10.

Additionally or alternatively, the corresponding surfaces or other portions of the frames, the reinforcement structure or both may be formed (e.g., molded) to have interlocking features for attaching the frames, the reinforcement structures or a combination thereof together during adhesive cure or any other time. For example, a corresponding surface of one frame or structure may include one or more openings (e.g., cavities) for receiving one or more protrusions of a corresponding surface of another frame or structure.

Generally, it is desirable for the adhesive to exhibit a reasonable amount of post-cure ductility. Preferably, the adhesive exhibits ductility that is as high as the ductility of the material that forms one of the frames or reinforcement structure 12, 14, 18.

Upon attachment of the frames to each other, one or more ducts are preferably formed by the frames. As can be seen in the Figures, the first frame 12 and the second frame 14 cooperatively form one or more air ducts 130. Preferably, the ducts 130, 132 are employed as part of a heating, ventilating and air conditioning (HVAC) ducting system of the automotive vehicle. As such, the ducts 130, 132 are preferably in fluid communication with a source (not shown) of conditioned air.

In the preferred embodiment illustrated, the first frame 12 and the second frame 14 cooperatively enclose and combine their respective cavities 26, 30, 54 to form a pair of ducts 130, 132, at least one of which provides fluid communication between the source of conditioned air and the openings 72 (e.g., tunnels) formed by the tubular structures 70 of the second frame 14. In turn, the openings 72 can provide conditioned air to an interior cabin of a vehicle. Optionally, the opening 44 in the first frame 12 can profice fluid communication between the source of conditioned air and the duct 130.

Although not required, it may be desirable to cover surfaces (e.g., of the frames or both), which defines the ducts for preventing corrosion, condensation or the like. Suitable coverings may include coatings such as paints, primers or the like. Alternatively, films or or other coverings of plastic or polymeric material may also be employed to coat the surfaces.

The reinforcement structure 18 and a peripheral component shown as a steering column 140 are preferably attached to the first frame 12 with mechanical fasteners 142 (e.g., 2 or 4 clamps, bolts, combinations thereof or the like). Of course, it is contemplated that multiple other attachments may be employed and that separate or same fasteners may be employed for attaching the steering column 140 to the first frame 12 and the reinforcement structure 18 to the first frame 12.

In the embodiment shown, the fasteners 142 each include or share a member 144 that is secured (e.g., welded, adhered or otherwise) to the peripheral component 140. The fasteners 142 are each additionally fastened (e.g., clamped or threadably fastened) to the portion 22 of the first frame 12. While not shown, it is contemplated that the peripheral component may also be fastened to the reinforcement structure 18 (e.g., the central member of the reinforcement structure).

The reinforcement structure 18 is also illustrated, particularly in FIG. 4, as being attached to the support members 40 below the portion 22 of the first frame 22. In this manner, the reinforcement structure 18 forms a removable bridge for providing structural integrity to the portion 22 of the first frame 22. As shown, the attachment members 80 of the reinforcement structure 18 are attached to the support members 40 with mechanical fasteners 148 (e.g., bolts, clamps, clips or the like) such that the steering column 144 extends at least partially between the attachment members 80. Additionally or alternatively, the attachment members 80 may be attached to the support members 40 or other portions of the main frame 12 with mechanical fasteners, adhesives or any other attachments discussed herein.

As shown, loads or forces (as shown by arrow 200) are placed upon the portion 22 of the main frame 12 by the steering column 140. In turn, the forces or loads tend to flex the portion 22 of the frame 12 thereby moving the support member 40 outwardly away from each other (as shown by arrows 202). Advantageously, however, the reinforcement structure 18, and particularly the central member 82, by bridging the support members 22, is placed in tension for assisting the support members 40 in resisting such outward movement. In turn, the reinforcement the reinforcement structure 18 also resists the flex of the portion 22 of the frame 12. In this manner, the reinforcement structure 18 assists in providing overall structural integrity to the portion 22, the main frame 12, the instrument panel assembly 10 or a combination thereof.

As an added advantage, the one or more frames 12, 14 or structure 18 of the instrument panel assembly 10 can be formed substantially entirely of plastic without requiring additional metal supports or reinforcements exending laterally with the frames 12, 14. Thus, in one preferred embodiment, the main frame 12 extends laterally across a length (L) (e.g., a length that traverses substantially entirely laterally across an automotive vehicle) and the instrument panel assembly 10 is devoid of any metal or other supports extending laterally with the main frame 12 a distance that is 40%, more preferably 70% and even more preferably 90% of the length (L).

It is contemplated that various installation methods may be employed for assembling the instrument panel assembly to an article of manufacture and, more particularly, to a transportation vehicle. For example, the instrument panel assembly may be attached to a transportation vehicle with mechanical fasteners, welding techniques, adhesives or the like.

In a particularly preferred embodiment, frames 12, 14 of the instrument panel assembly 10 exend between distal ends 150, 152 and mechanical fasteners (e.g., brackets) are provided at distal ends 150, 152 of the assembly 10. Preferably, the fasteners are configured for attachment to the frame of an automotive vehicle and, more particularly, to pillars (e.g., A-pillars, hinge pillars or the like) of the frame of an automotive vehicle.

It is also contemplated that the instrument panel assembly 10 may be attached to a windshield frame structure (e.g., a windshiel fence line). As an example, the depicted assembly 10 includes tabs 250, which may be fastened (e.g., adhered or mechanical fastened) to the windshield frame structure.

The foregoing discussion discloses and describes merely exemplary embodiments of the present invention. One skilled in the art will readily recognize from such discussion and from the accompanying drawings and claims, that various changes, modifications and variations can be made therein without departing from the spirit and scope of the invention as defined in the following claims. In particular regard to the various functions performed by the above described components, assemblies, devices, compositions, etc., the terms used to describe such items are intended to correspond, unless otherwise indicated, to any item that performs the specified function of the described item, even though not necessarily structurally equivalent to the disclosed structure. In addition, while a particular feature of the invention may have been described above with respect to only one of the embodiments, such feature may be combined with one or more other features of other illustrated embodiments.

What is claimed is:

1. A method of forming a instrument panel assembly for a transportation vehicle, comprising:
attaching a reinforcement together with a frame; and
attaching a peripheral component to at least one of the frame and the reinforcement structure;
wherein at least a portion of the reinforcement structure is placed in tension for supporting a steering column.

2. A method of forming a instrument panel assembly for a transportation vehicle, comprising:
forming a first frame of a first plastic material, the first frame including a first portion and a pair of support members;
forming a reinforcement structure of a second plastic material, the reinforcement structure including a pair of attachment members and a central portion bridging the attachment portions;
attaching the reinforcement structure to the support members of the main frame; and
attaching the steering column to one or a combination of the first portion of the first frame and the the reinforcement structure;
wherein the reinforcement structure resists flex of the first portion of the frame due to a load placed upon the first portion by the steering column thereby providing structural integrity to the first frame.

3. A method of forming a instrument panel assembly for a automotive vehicle, comprising:
forming a first frame entirely formed of a first plastic material, the first frame configured to extend laterally substantially entirely across the vehicle, the first frame including a first portion and a pair of support members and the first frame defining a cavity;
forming a second frame entirely formed of a second plastic material, the second frame configure to extend laterally with the first frame, the second frame defining a cavity, the second frame including a plurality of tubular structures defining tunnels;
forming a reinforcement structure of a third plastic material for assisiting in supporting a steering column of the transportation vehicle, the reinforcement structure including a pair of attachment members and a central portion bridging the attachment portions;
attaching the first frame to the second frame such that the cavity of the first frame cooperatively forms a duct with the cavity of the second frame, the duct being in fluid communication with the tunnels wherein both the duct and the tunnels are configured for receiving conditioned air as part of an HVAC system; and
attaching the reinforcement structure to the support members of the main frame;
attaching the steering wheel column to one or a combination of the first portion of the first frame and the the reinforcement structure; and
wherein the reinforcement structure resists flex of the first portion of the frame due to a load placed upon the first portion by the steering column thereby providing structural integrity to the first frame.

4. A method according to claim 1 wherein the frame and the reinforcement structure are formed substantially entirely of plastic.

5. A method according to claim 4 wherein the peripheral component is a steering wheel column.

6. A method according to claim 5 wherein at least one of the frame and the reinforcement structure are forming by molding using a process selected from injection molding or compression molding.

7. A method according to claim 2 wherein at least one of the first frame and the reinforcement structure are formed by molding using a process selected from injection molding or compression molding.

8. A method according to 3 wherein at least one of the first frame and the reinforcement structure are formed by molding using a process selected from injection molding and compression molding.

9. A method according to claim 3 wherein the first frame includes one or more corresponding surfaces that are adhesively secured with an adhesive to one or more corresponding surfaces of the second frame and wherein the one or more corresponding surfaces of first frame or the one or more corresponding surfaces of second frame are low energy surfaces.

10. A method according to claim 5 wherein the plastic comprises a homopolymer selected from a polyolefin, a polystyrene and a polyamide or a copolymer.

11. A method according to claim 2 wherein the first plastic material comprises a homopolymer selected from a polyolefin, a polystyrene and a polyamide or a copolymer.

12. A method according to claim 3 wherein the first plastic material comprises a homopolymer selected from a polyolefin, a polystyrene and a polyamide or a copolymer.

13. A method according to claim 5 wherein the plastic includes a reinforcement material selected from a fiber and a mineral.

14. A method according to claim 2 wherein the first plastic material includes a reinforcement material selected from a fiber and a mineral.

15. A method according to claim 3 wherein the plastic material includes a reinforcement material selected from a fiber and a mineral.

16. A method according to claim 5 wherein the first frame extends from one hinge pillar of an automotive vehicle to another hinge pillar of the automotive vehicle.

17. A method according to claim 2 wherein the first frame extends from one hinge pillar of the transportation vehicle to another hinge pillar of the transportation vehicle.

18. A method according to claim 3 wherein the steering wheel column extends between the attachment members.

19. A method according to claim 2 wherein the first frame extends laterally across a length and the assembly is devoid of any metal supports extending laterally with the main frame 12 a distance that is 70% of the length.

20. A method according to claim 3 wherein the first frame extends laterally across a length and the assembly is devoid of any metal supports extending laterally with the main frame 12 a distance that is 70% of the length.
